(19) United States
(12) Patent Application Publication
(10) Pub. No.: US 2016/0210366 A1
(43) Pub. Date: Jul. 21, 2016

(54) METHOD AND APPARATUS FOR PROVIDING MEDIA RESOURCE

(71) Applicant: Xiaomi Inc., Beijing (CN)

(72) Inventors: Tiejun LIU, Beijing (CN); Guang JIA, Beijing (CN); Pengfei ZHANG, Beijing (CN)

(73) Assignee: Xiaomi Inc.

(21) Appl. No.: 15/080,836

(22) Filed: Mar. 25, 2016

Related U.S. Application Data
(63) Continuation of application No. PCT/CN2015/093855, filed on Nov. 5, 2015.

(30) Foreign Application Priority Data
Nov. 6, 2014 (CN) 201410641975.2

(51) Int. Cl. G06F 17/30; H04L 29/06

(52) U.S. Cl. CPC G06F 17/30864; H04L 65/60; G06F 17/30876

(57) ABSTRACT

A method for a router to feed back a media resource includes receiving an access request sent from a terminal device. The access request is for obtaining a requested media resource and carries a data identifier corresponding to the media resource. The method further includes querying whether the router stores a media resource corresponding to the data identifier and feeding the stored media resource back to the terminal device as the requested media resource if the router stores the media resource corresponding to the data identifier.

### CROSS-REFERENCE TO RELATED APPLICATIONS

This application is a Continuation Application of International Application PCT/CN2015/093855, with an international filing date of Nov. 5, 2015, which claims priority to Chinese Patent Application 201410641975.2, filed Nov. 6, 2014, the entire contents of both of which are incorporated herein by reference.

### TECHNICAL FIELD

The present disclosure relates to network communication and, more particularly, to a method and apparatus for providing media resources.

### BACKGROUND

To obtain a media resource, an electronic device first transmits an access address for accessing the media resource to a router. The router forwards the access address to a corresponding server, which returns the media resource to the router based on the access address. The router then forwards the media resource to the electronic device.

According to the process described above, when the router receives a same access address more than one time, the router will always forward the access address to the server, which returns the same media resource every time. As a result, network traffic is increased.

### SUMMARY

In accordance with the present disclosure, there is provided a method for a router to feed back a media resource. The method includes receiving an access request sent from a terminal device. The access request is for obtaining a requested media resource and carries a data identifier corresponding to the media resource. The method further includes querying whether the router stores a media resource corresponding to the data identifier and feeding the stored media resource back to the terminal device as the requested media resource if the router stores the media resource corresponding to the data identifier.

Also in accordance with the present disclosure, there is provided a router including a processor and a memory storing instructions. The instructions, when executed by the processor, cause the processor to receive an access request sent from a terminal device. The access request is for obtaining a requested media resource and carries a data identifier corresponding to the media resource. The instructions further cause the processor to query whether the router stores a media resource corresponding to the data identifier and feed the stored media resource back to the terminal device as the requested media resource if the router stores the media resource corresponding to the data identifier.

Also in accordance with the present disclosure, there is provided a non-transitory computer-readable storage medium having stored therein instructions that, when executed by a processor of a router, cause the router to receive an access request sent from a terminal device. The access request is for obtaining a requested media resource and carries a data identifier corresponding to the media resource. The instructions further cause the processor to query whether the router stores a media resource corresponding to the data identifier and feed the stored media resource back to the terminal device as the requested media resource if the router stores the media resource corresponding to the data identifier.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart illustrating a method for feeding back a media resource according to an exemplary embodiment.

FIG. 2 is a flow chart illustrating a method for feeding back a media resource according to another exemplary embodiment.

FIG. 3 is a block diagram illustrating an apparatus for feeding back a media resource according to an exemplary embodiment.

FIG. 4 is a block diagram illustrating an apparatus for feeding back a media resource according to another exemplary embodiment.

FIG. 5 is a block diagram illustrating a device for feeding back a media resource according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

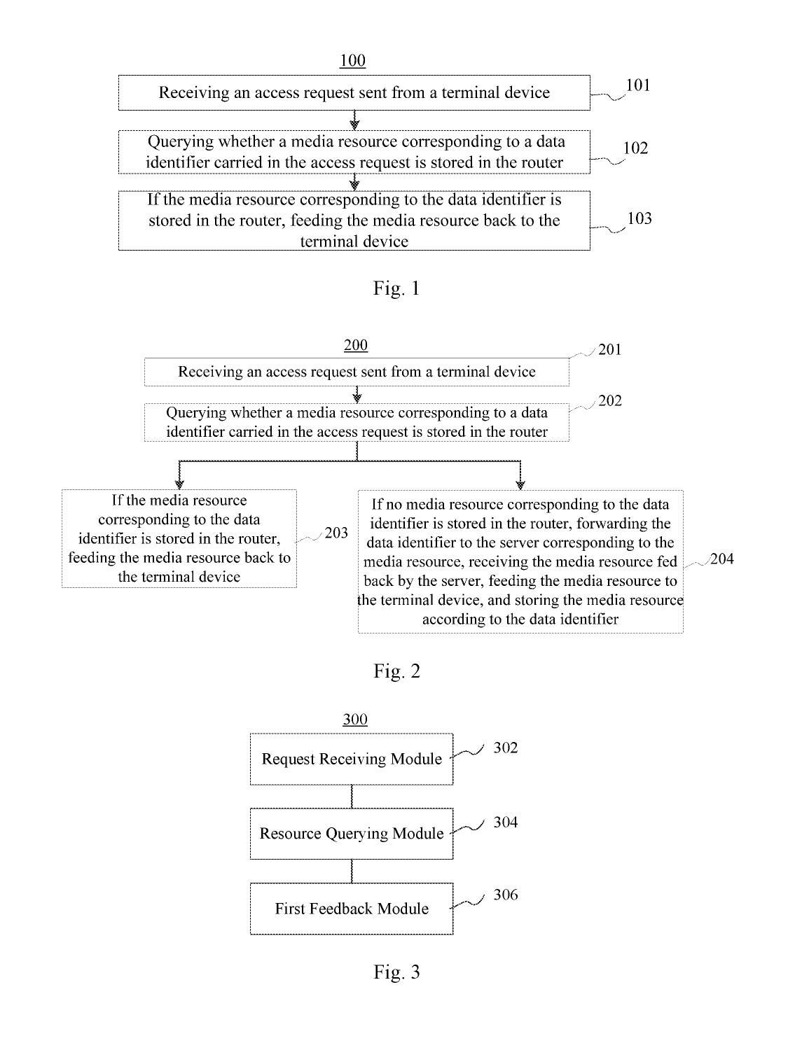

FIG. 1 is a flow chart illustrating a method 100 for feeding back a media resource according to an exemplary embodiment. The method 100 can be implemented, for example, in a router. As shown in FIG. 1, at 101, the router receives an access request sent from a terminal device. The request is for obtaining a specific media resource and carries a data identifier. The media resource can be any type of resource available through a network, such as music resource, video resource, or image resource. At 102, it is queried whether a media resource corresponding to the data identifier is stored in the router. At 103, if the media resource corresponding to the data identifier is stored in the router, the media resource stored in the router is fed back to the terminal device.

FIG. 2 is a flow chart illustrating a method 200 for feeding back a media resource according to another exemplary embodiment. The method 200 can be implemented, for example, in a router. As shown in FIG. 2, at 201, the router receives an access request sent from a terminal device. The request is for obtaining a specific media resource and carries a data identifier. The media resource can be any type of resource available through a network, such as music resource, video resource, or image resource.

A data identifier is generally carried in the access request and can be, for example, an access address or an identifier of a media resource in a server. The access address can be a network address for providing the media resource, such as a Uniform Resource Locator (URL). The access address can be generally used to indicate a storage location of a corresponding media resource on the network.

Before being sent to the router, the access request is encapsulated by the terminal device according to the Open System Interconnection (OSI) 7-layer protocol. Accordingly, the access request received by the router usually encapsulates the data identifier. The access request can be considered as a data packet. When the router receives the data packet encapsulating the data identifier, the router can decapsulate the data packet according to the OSI 7-layer protocol to obtain the data identifier.

In some embodiments, when the router receives the data packet encapsulating the data identifier sent from the terminal device, the router can intercept the data packet. For example, the data packet can be intercepted by means of a Netfilter framework. In Internet Protocol version 4 (IPv4), five hook functions are defined. When the data packet flows through a key position, a corresponding hook function will be called. After the data packet is verified according to the Internet Protocol (IP), at the data packet is processed by the first hook function NF_IP_PRE_ROUTING; which is used to determine whether the data packet is to be forwarded to an extranet server or the current router. As the data packet needs to be parsed, the hook function NF_IP_PRE_ROUTING can be configured to send all data packets to an upper layer protocol of the current router for parsing. The parsing result determines whether the data packet is forwarded to the server. The data packet sent to the upper layer protocol of the router is decapsulated by the OSI protocol in the router to restore the data identifier of the media resource sent from the terminal device.

That is, after the router receives a data packet corresponding to the access request sent from the terminal device, the router always sends the data packet to the upper layer protocol for decapsulating to obtain the data identifier in the data packet, rather than directly forwarding the data packet to a corresponding extranet server.

At 202, it is queried whether a media resource corresponding to the data identifier is stored in the router.

In some embodiments, in order to facilitate retrieval of the media resource, media resources in the router can be stored by category according to types of the media resources. Accordingly, before querying whether the media resource corresponding to the data identifier is stored, the router can determine a type of the media resource. Furthermore, to query whether the media resource corresponding to the data identifier is stored, the router can query whether a media resource corresponding to the data identifier is stored in a storage space of the router corresponding to the type.

That is, media resources stored in the router can be managed by category and media resources of a same type can be stored in a same category. As such, the querying process can be more efficiently performed.

In some embodiments, in order to determine the type of the media resource, a suffix of the data identifier, e.g., an access address, corresponding to the media resource can be utilized. For example, an access address of a media resource: http://www.xxx.com/music/123.mp3, indicates that a file with a file named 123.mp3 is requested. A suffix mp3 in the file name indicates the file is a music file. After the type of the media resource is determined, the router can query whether a media resource having a same name as the file name in the data identifier is stored in a storage space of the router corresponding to the type of music files. That is, in the querying process, the router can query whether a media resource having a same name as the file name in the data identifier is stored in the router according to the data identifier carried in the access request.

Sometimes, media resources of different types may have the same file name and thus may cause feedback error. To solve this problem, the router can use data identifiers, rather than file names, as indices when storing media resources. Accordingly, the router can query whether a media resource having a same name as the data identifier is stored in the router.

For example, if the data identifier of a media resource is an access address, the router can use the access address, rather than the file name of the media resource, when storing the media resource. Thereafter, the router can query whether a media resource with the access address as its name is stored therein.

In some embodiments, to query whether a media resource having a name that is the same as the data identifier is stored in the router, the router can either query directly in the entire storage whether a media resource having a name that is the same as the data identifier is stored, or query in a storage space corresponding to the type of the media resource whether a media resource having a name that is the same as the data identifier is stored.

As described above, a typical data identifier can be, for example, an access address, which may be relatively long. When a large number of media resources are stored in the router using their corresponding access addresses as names, the access addresses can occupy a large storage space. Moreover, using access addresses for matching can also be complex and time consuming. Accordingly, to reduce the storage space occupied by the media resources and also to reduce the matching complexity and time consumption, the router can process the data identifiers of the media resources to generate processed names, which have fewer characters than corresponding data identifiers.

For example, the router can process the data identifier of a media resource according to a preset processing rule to obtain a character string with fewer characters than the data identifier. Typically, the character string, obtained by processing characters of the data identifier according to the preset processing rule, should correspond uniquely to the data identifier. The preset processing rule can be, for example, an algorithm that is capable of reducing the number of characters of the data identifier, such as a hash algorithm.

For example, a data identifier, e.g., an access address, of a certain media resource is http://www.xxx.com/music/123.mp3, which has 32 characters. Processing the access address of the media resource by hash operations results in ADF2JLSD2JL093JSDLAD, which has 20 characters. Accordingly, the character string obtained by hash operations has fewer characters than the data identifier.

Thus, after the data identifier of a media resource is processed according to the preset processing rule to obtain a character string, the character string can be used as a name of the media resource to be stored corresponding to the data identifier. In this scenario, to query whether a media resource corresponding to the data identifier is stored in the router, the router first processes the data identifier carried in the access request according to the preset processing rule to obtain a character string uniquely corresponding to the data identifier. The router then queries whether a media resource having a name that is the same as the character string is stored in the router.

As described above, media resources stored in the router can be managed by category and media resources of a same type can be stored in a same category. Accordingly, to retrieve a media resource in the router, a type of the media resource can be determined first, and then it can be queried whether a media resource having a name that is the same as the obtained character string is stored in a storage space corresponding to the type of the media resource.

That is, the router can either query directly in the entire storage of the router whether a media resource having a name that is the same as the character string is stored, or query in a storage space corresponding to the type of the media resource whether a media resource having a name that is the same as the character string is stored.

Table 1 is an exemplary table created for storing media resources by category. As shown in Table 1, the router divides media resources into categories of music, video, and image. Thus, Table 1 includes three category rows, each of which stores names of media resources having the corresponding type as indices. That is, a media resource is stored with the type of the media resource as a primary index and the name of the media resource as a secondary index.

In order to retrieve a media resource, a type corresponding to the media resource can be first determined by searching the primary indices, and then the media resource can be searched based on the secondary indices in a storage space corresponding to the type. For example, referring to Table 1, in order to retrieve a media resource with a type “music” and a processed name “ADF01JFSD4R,” the type “music” of the media resource can be first determined, and then the media resource having the name “ADF01JFSD4R” can be searched in a storage space corresponding to the music type.

TABLE 1

| Resource Type | Name of Media Resource | | | | |
|---|---|---|---|---|---|
| Music | ADF1JFSD1R | ADF1JFSD2R | ADF1JFSD03R | ADF01JFSD4R | ADF1JFSD5R |
| Video | ADF12JFSD1R | ADF2JFSD2R | ADF21JFSD3R | ADF2JFSD84R | ADF2JFSD5R |
| Image | ADF3JFSD1R | ADF3JFSD02R | ADF3JFSD35R | ADF31JFSD4R | ADF39JFSD5R |

At 203, if the media resource corresponding to the data identifier is stored in the router, the media resource stored in the router is fed back to the terminal device. Further, the router can discard the data packet corresponding to the data identifier, rather than forwarding the data packet with the data identifier encapsulated therein to the extranet server. As a result, response speed of the router and user experience can be improved.

At 204, if no media resource corresponding to the data identifier is stored in the router, the data identifier is forwarded to the server corresponding to the media resource. The data identifier is used to trigger the server to feed the media resource corresponding to the data identifier back to the router. When the router receives the media resource fed back by the server, the router feeds the received media resource back to the terminal device, and stores the received media resource according to the data identifier corresponding to the received media resource.

That is, if it is determined at 202 that no media resource corresponding to the data identifier is stored in the router, the router needs to encapsulate the data identifier into a data packet according to the OSI 7-layer protocol, and forward the data packet with the data identifier encapsulated therein to the server corresponding to the data identifier. Upon receiving the data packet, the server decapsulates the data packet according to the OSI 7-layer protocol to obtain the data identifier encapsulated therein. According to the present disclosure, the data packet with the data identifier encapsulated therein, which is sent to the server by the router, can trigger the server to feed the media resource back to the router. Thus, the server retrieves the media resource and feeds the retrieved media resource back to the router.

The router can store the media resource fed back by the server according to a preset rule. The router can store the received media resource according to a manner described above, such as that described above with respect to process 202. For example, the router can store the received media resource using the data identifier of the received media resource as a name of the received media resource. The router can store the received media resource directly in the storage of the router. Alternatively, the router can determine a type of the received media resource, and store the received media resource in a storage space of the router corresponding to the type.

An exemplary process consistent with the present disclosure will be described below, which includes playing back music online using a browser in a personal computer (PC). Alternatively, the process can be conducted using a different type of client terminal, such as a tablet, a mobile phone, or a multimedia player. Further, besides the PC, at least two other physical devices, i.e., a router and a web server in the public network, are involved in the process. The process can be performed with one or more PCs and/or one or more web servers.

In the exemplary process, the PC requests a music file (or alternatively a video file, an image file, etc.) with a request carrying an access address of the music file. For example, the access address of the music file is http://www.xxx.com/music/123.mp3. The PC can encapsulate the request into a data packet according to the OSI 7-layer model protocol.

The data packet is intercepted when it flows through the kernel of the router. The router parses the data packet after intercepting it. For example, a Netfilter framework can be utilized to intercept the data packet. That is, the data packet is processed by the first hook function NF_IP_PRE_ROUTING in the router and then arrives at a routing code, which determines whether the data packet is to be forwarded outside of the router or locally. In some embodiments, the routing code can be customized to transmit all received data packets to a local upper layer, such that the router parses the data packets locally to obtain the data identifier, and queries whether a corresponding media resource is stored in the router according to the data identifier.

After the data packet is parsed, an access address URL, http://www.xxx.com/music/123.mp3, carried in the request is obtained. According to the suffix of the access address, the router determines that the access address corresponds to a music file. The router searches in a hard disk of the router for a file corresponding to “http://www.xxx.com/music/123.mp3.” For example, the router can hash the access address “http://www.xxx. com/music/123.mp3” using a hash function to generate a hashed character string “ADF2JLSD2JL093JSDLAD,” and then search for a file having a name of “ADF2JLSD2JL093JSDLAD.” If the file exists, the router feeds the file back to the PC rather than forwarding the data packet to the public network. If such a file does not exist, the router forwards the data packet to the web server in the public network and locally caches the music file returned by the web server, with the hashed character string obtained by hashing the access address as the name of the music file.

As described above, when a music file is requested, if the requested music file is cached in the router, the music file can be fed back directly to the client terminal without being requested from the public network. Accordingly, the client terminal may still be able to play the music file online even if the router is not connected to the public network. That is, the router can serve as a private household music cloud center.

FIG. 3 is a block diagram illustrating an apparatus 300 for feeding back a media resource according to an exemplary embodiment. The apparatus 300 can be implemented, for example, in a router and, as shown in FIG. 3, includes a request receiving module 302, a resource querying module 304, and a first feedback module 306. The request receiving module 302 is configured to receive an access request sent from a terminal device. The request is for obtaining a specific media resource and carries a data identifier. The resource querying module 304 is configured to query whether a media resource corresponding to the data identifier is stored in the router. The first feedback module 306 is configured to feed the media resource stored in the router back to the terminal device if the resource query module 304 determines that the media resource corresponding to the data identifier is stored in the router.

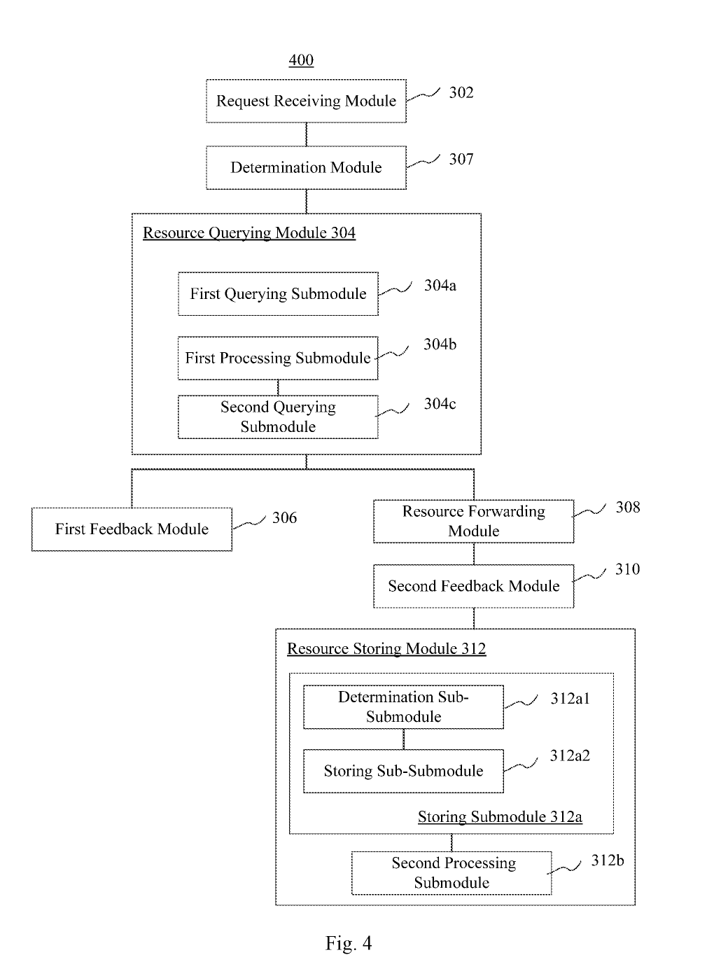

FIG. 4 is a block diagram illustrating an apparatus 400 for feeding back a media resource according to another exemplary embodiment. The apparatus 400 can be implemented, for example, in a router and, as shown in FIG. 4, includes the request receiving module 302, the resource querying module 304, the first feedback module 306, a determination module 307, a resource forwarding module 308, a second feedback module 310, and a resource storing module 312.

In some embodiments, as shown in FIG. 4, the resource querying module 304 includes a first query submodule 304a configured to query whether a media resource having a name that is the same as the data identifier is stored in the router.

In some embodiments, the resource querying module 304 includes a first processing submodule 304b and a second querying submodule 304c. The first processing submodule 304b is configured to generate a character string uniquely corresponding to the data identifier by processing the data identifier carried in the access request according to a preset processing rule. The preset processing rule is used to reduce the number of characters of the data identifier. The second querying submodule 304c is configured to query whether a media resource having a name that is the same as the character string is stored in the router.

The determination module 307 is configured to determine a type of the media resource. The resource querying module 304 is further configured to query whether a media resource corresponding to the data identifier is stored in a storage space of the router corresponding to the type determined by the determination module 307.

The resource forwarding module 308 is configured to forward the data identifier to a server corresponding to the media resource if the resource querying module 304 determines that no media resource corresponding to the data identifier is stored in the router. The data identifier can trigger the server to feed the media resource corresponding to the data identifier back to the router.

The second feedback module 310 is configured to receive the media resource fed back by the server and feed the received media resource back to the terminal device.

The resource storing module 312 is configured to store the media resource according to the data identifier.

In some embodiments, as shown in FIG. 4, the resource storing module 312 includes a storing submodule 312a configured to store the media resource with the data identifier of the media resource as a name of the media resource.

In some embodiments, as shown in FIG. 4, the resource storing module 312 includes a second processing submodule 312b configured to generate a character string uniquely corresponding to the data identifier by processing the data identifier according to a preset processing rule. The preset processing rule is used to reduce the number of characters of the data identifier. The storing submodule 312a is further configured to store the media resource with the character string as a name of the media resource.

In some embodiments, as shown in FIG. 4, the storing submodule 312a includes a determination sub-submodule 312a1 and a storing sub-submodule 312a2. The determination sub-submodule 312a1 is configured to determine a type of the media resource. The storing sub-submodule 312a2 is configured to store the media resource into a storage space corresponding to the type.

Specific operations of individual modules in the above-described exemplary apparatus are the same as or similar to the methods described above, and thus are not repeated

According to the present disclosure, there is provided a device for feeding back a media resource. The device includes a processor and a memory storing instructions that, when executed by the processor, cause the processor to perform a method consistent with the present disclosure, such as one of the exemplary methods described above.

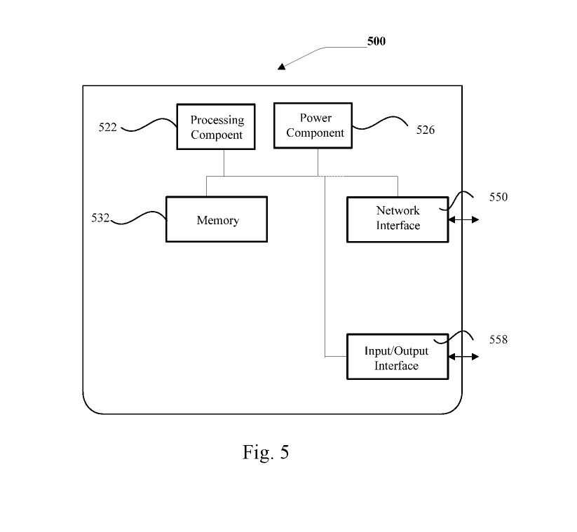

FIG. 5 is a block diagram of a device 500 for feeding back a media resource, according to an exemplary embodiment. For example, the device 500 may be provided as a router. Referring to FIG. 5, the device 500 includes a processing component 522 that further includes one or more processors, and memory resources represented by a memory 532 for storing instructions executable by the processing component 522, such as application programs. The application programs stored in the memory 532 may include one or more modules each corresponding to a set of instructions. Further, the processing component 522 is configured to execute the instructions to perform a method consistent with the present disclosure, such as one of the above-described methods for feeding back a media resource.

The device 500 may also include a power component 526 configured to perform power management of the device 500, wired or wireless network interface(s) 550 configured to connect the device 500 to a network, and an input/output (I/O) interface 558. The device 500 may operate based on an operating system stored in the memory 532, such as Windows Server™, Mac OS X™, Unix™, Linux™, FreeBSD™, or the like.

According to the present disclosure, the same media resource does not need to be transmitted multiple times, and thus network traffic can be reduced. Moreover, media resources can be stored in different storage spaces of the router according to the types of the media resources. As such, searching time can be reduced and thus searching efficiency can be improved.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for a router to feed back a media resource, comprising:
receiving an access request sent from a terminal device, for obtaining a requested media resource, the request carrying a data identifier corresponding to the media resource;
querying, according to the data identifier, whether the router stores a media resource corresponding to the data identifier; and
feeding, if the router stores the media resource corresponding to the data identifier, the stored media resource back to the terminal device as the requested media resource.

2. The method of claim 1, wherein querying whether the router stores the media resource corresponding to the data identifier includes:
querying, according to the data identifier, whether the router stores a media resource having a name that is the same as the data identifier.

3. The method of claim 1, wherein querying whether the router stores the media resource corresponding to the data identifier includes:
generating a character string uniquely corresponding to the data identifier by processing the data identifier according to a preset processing rule that reduces a number of characters of the data identifier; and
querying whether the router stores a media resource having a name that is the same as the character string.

4. The method of claim 1, further comprising, before querying:
determining a type of the media resource,
wherein querying whether the router stores the media resource corresponding to the data identifier includes querying whether the router stores a media resource corresponding to the data identifier in a storage space corresponding to the type.

5. The method of claim 1, further comprising:
forwarding, if therouter does not store a media resource corresponding to the data identifier, the data identifier to a server corresponding to the requested media resource;
receiving the requested media resource fed back by the server;
feeding the requested media resource received from the server to the terminal device; and
storing the requested media resource according to the data identifier.

6. The method of claim 5, wherein storing the requested media resource includes:
storing the requested media resource with the data identifier of the media resource as a name of the media resource.

7. The method of claim 5, wherein storing the requested media resource includes:
generating a character string uniquely corresponding to the data identifier by processing the data identifier according to a preset processing rule that reduces a number of characters of the data identifier; and
storing the requested media resource with the character string as a name of the media resource.

8. The method of claim 5, wherein storing the requested media resource includes:
determining a type of the requested media resource; and
storing the requested media resource into a storage space corresponding to the type.

9. A router, comprising:
a processor; and
a memory storing instructions that, when executed by the processor, cause the processor to:
receive an access request sent from a terminal device, for obtaining a requested media resource, the request carrying a data identifier corresponding to the media resource;
query, according to the data identifier, whether the router stores a media resource corresponding to the data identifier; and
feed, if the router stores the media resource corresponding to the data identifier, the stored media resource back to the terminal device as the requested media resource.

10. The router of claim 9, wherein the instructions further cause the processor to:
query, according to the data identifier, whether the router stores a media resource having a name that is the same as the data identifier.

11. The router of claim 9, wherein the instructions further cause the processor to:
generate a character string uniquely corresponding to the data identifier by processing the data identifier according to a preset processing rule that reduces a number of characters of the data identifier; and
query whether the router stores a media resource having a name that is the same as the character string.

12. The router of claim 9, wherein the instructions further cause the processor to, before querying:
determine a type of the media resource; and
query whether the router stores a media resource corresponding to the data identifier in a storage space corresponding to the type.

13. The router of claim 9, wherein the instructions further cause the processor to:
forward, if the router does not store a media resource corresponding to the data identifier, the data identifier to a server corresponding to the requested media resource;
receive the requested media resource fed back by the server;
feed the requested media resource received from the server to the terminal device; and
store the requested media resource according to the data identifier.

14. The apparatus of claim 13, wherein the instructions further cause the processor to:
store the requested media resource with the data identifier of the media resource as a name of the media resource.

15. The apparatus of claim 13, wherein the instructions further cause the processor to:
generate a character string uniquely corresponding to the data identifier by processing the data identifier according to a preset processing rule that reduces a number of characters of the data identifier; and
store the requested media resource with the character string as a name of the media resource.

16. The apparatus of claim 13, wherein the instructions further cause the processor to:
determine a type of the requested media resource; and
store the requested media resource into a storage space corresponding to the type.

17. A non-transitory computer-readable storage medium having stored therein instructions that, when executed by a processor of a router, cause the router to:
receive an access request sent from a terminal device, for obtaining a requested media resource, the request carrying a data identifier corresponding to the media resource;
query, according to the data identifier, whether the router stores a media resource corresponding to the data identifier; and
feed, if the router stores the media resource corresponding to the data identifier, the stored media resource back to the terminal device as the requested media resource.
